(19) United States
(12) Patent Application Publication
(10) Pub. No.: US 2023/0130143 A1
(43) Pub. Date: Apr. 27, 2023

(54) REAL ESTATE SEARCH AND TRANSACTION SYSTEM AND METHOD

(71) Applicant: Santosh Chandy, Chicago, IL (US)

(72) Inventor: Santosh Chandy, Chicago, IL (US)

(21) Appl. No.: 17/509,445

(22) Filed: Oct. 25, 2021

(51) Int. Cl. G06Q 30/06; G06F 16/951; G06F 16/9538; G06F 16/9535; G06Q 50/16

(52) U.S. Cl. CPC G06Q 30/0643; G06F 16/951; G06F 16/9538; G06F 16/9535; G06Q 50/16

(57) ABSTRACT

A real estate database search and real estate transaction system and method are disclosed. The system includes a server and a mobile device running a software application. In response to a search request from the mobile device, the server determines an initial set of listings from a listings database. The mobile device displays a sequence of questions to a buyer user to narrow the initial set of listings to a focus target number of listings. The user answers the questions by swiping a touch screen display of the mobile device in a selected direction, and the server narrows the listings until the target number is reached. The focused selection of listings is displayed to the buyer user in an interactive format allowing the buyer user to request a showing, transmit a purchase offer, negotiate a purchase contract with a seller, and generate the negotiated contract.

### CROSS REFERENCE

NONE.

### FIELD OF THE INVENTION

The present disclosure relates to a software system for the purchase of real estate. More particularly, the disclosure relates to a cloud based software system operating across servers, computers and mobile devices that facilitate the purchase of real estate without the intervention of a broker, and even more particularly still, the disclosure relates to a cloud based software system operating across servers, computers and mobile devices that facilitate the purchase of real estate without the intervention of a broker through the use of swipe gestures by a user using a mobile device.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present disclosure, or any embodiments thereof, to anything stated or implied therein or inferred thereupon.

### SUMMARY

According to an aspect of the disclosure, a cloud based real estate database search system is disclosed. The real estate search system comprises a server including a processor and a memory. The search system further includes a mobile device that includes a processor, a memory, and a touch screen display. The mobile device is communicatively coupled or linked to the server by a network, which can be, for example, the Internet. The system further comprises a software application operative to run on the server and the mobile device, whereby the server and the mobile application are adapted to run the software application to:

Access, by the server, a database of real estate listings;

Determine, by the server, an initial set of the listings from the database based on at least one criterion transmitted to the server by the mobile device;

Determine whether a number of listings in the initial set of the listings from the database is greater than a focus target number of listings;

When the number of listings in the initial set of listings is less than or equal to the focus target number of listings, designate, by the server, the initial set of listings as a focused listings selection, and deliver by the server the focused listings selection to the mobile device by the network, and display at the mobile device, the focused listings selection on the touch screen display.

Displaying a question on the touch screen display;

Receiving at the mobile device an answer to the question, with the answer being indicated by the user swiping the touch screen display in a selected one of a plurality of directions to indicate a selected one of a plurality of answers;

Transmitting the answer from the mobile device to the server;

Filtering, at the server, the initial set of listings to remove listings based on the answer;

Determining whether the number of remaining listings is from the initial set is greater than the focus target number of listings;

Delivering the remaining focused listings to the mobile device;

Displaying at the mobile device the remaining focused listings on the touch screen display; and

Repeating the above steps as necessary to help a user arrive at selected real estate listing.

### BRIEF DESCRIPTION OF THE DRAWINGS

Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a schematic diagram of a real estate database search system according to an embodiment of the disclosure.

FIG. 2 is a block diagram of a real estate database search method according to an embodiment of the disclosure.

FIG. 3 is a schematic illustration of a portion of the method of FIG. 2.

FIG. 4 is an illustration of a user real estate transaction interface according to an embodiment of the disclosure.

A person of ordinary skill in the art will appreciate that elements of the figures above are illustrated for simplicity and clarity and are not necessarily drawn to scale. The dimensions of some elements in the figures may have been exaggerated relative to other elements to help understanding of the present teachings. Furthermore, a particular order in which certain elements, parts, components, modules, steps, actions, events and/or processes are described or illustrated may not be actually required. A person of ordinary skill in the art will appreciate that, for the purpose of simplicity and clarity of illustration, some commonly known and well-understood elements that are useful and/or necessary in a commercially feasible embodiment may not be depicted in order to provide a clear view of various embodiments in accordance with the present teachings.

### DETAILED DESCRIPTION

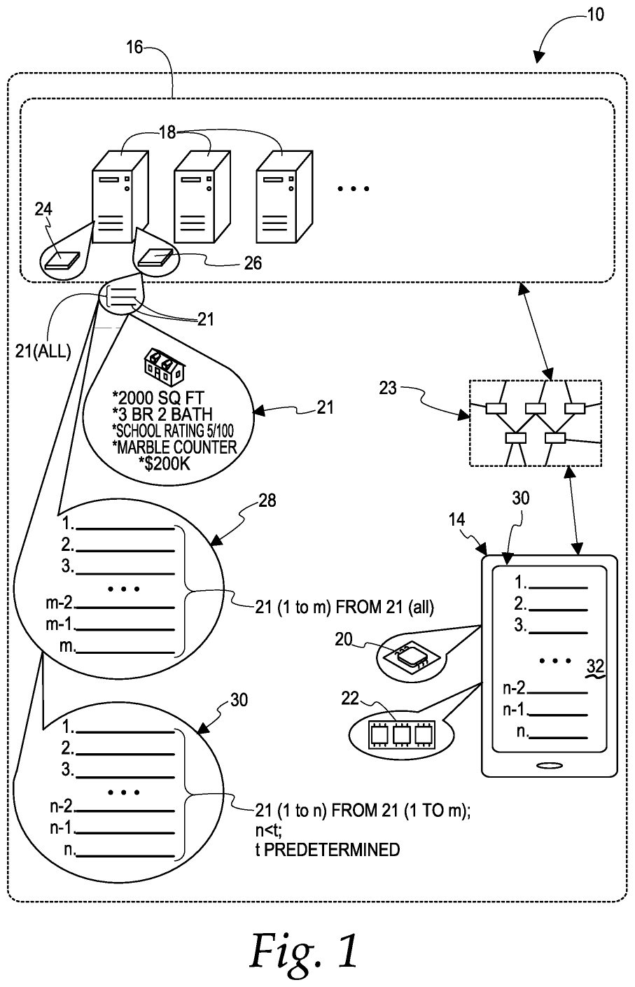

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, unless otherwise clearly stated, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting unless the claims expressly state otherwise.

A system and method for transacting in real estate without an agent are disclosed, which allow potential buyers to shop for and purchase a home. A system according to the disclosure is intended to exclude real estate agents (such as members of the National Association of Realtors®) from the purchasing process. In particular, the system allows a buyer to schedule a showing, present an offer, negotiate a contract, and forward the contract to an attorney of the buyer's choosing without involving a real estate agent.

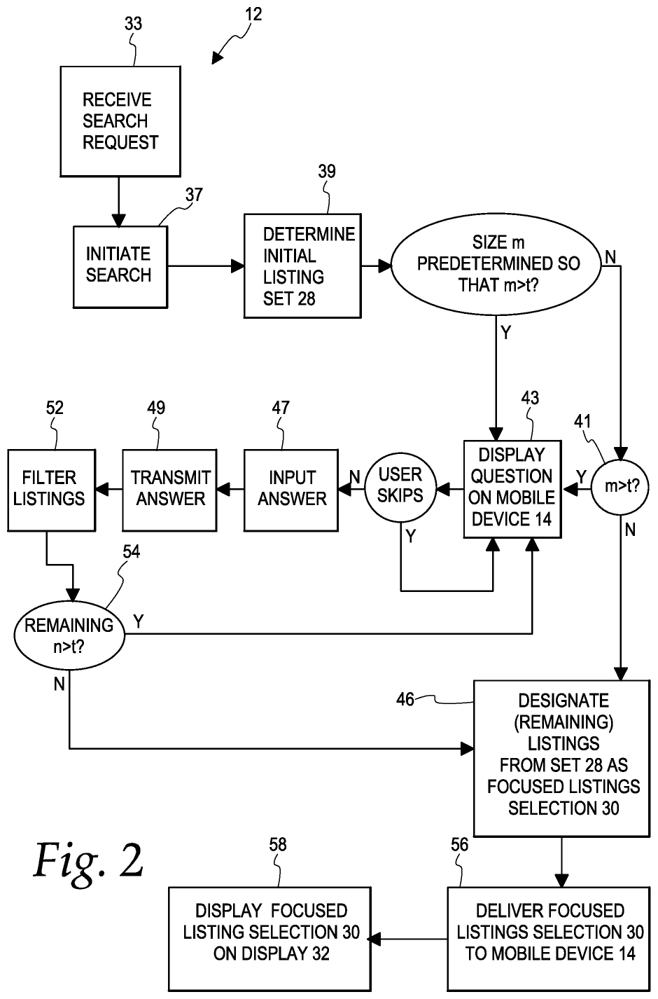

Now described are embodiments of real estate transaction systems and methods according to the disclosure, including a system 10 as illustrated in the system diagram of FIG. 1 and a software-implemented method 12 as illustrated in the block diagram of FIG. 2. The system 10 comprises a software application, which will generally operate on a mobile device 14, such as a smartphone or tablet, as well as a server system 16, also referred to herein as a server 16. The server 16 comprises one or more server devices 18 that are operative to gather, process, search, and/or maintain a database 19 of real property listings 21, collectively designated in FIG. 1 as listings 21(all), and to transmit one or more of the listings 21 to the mobile device 14 via a network 23, where the network 23 may include all or portions of a combination of networks, such as a local area network (LAN), a wide area network (WAN), a telephone network, such as the Public Switched Telephone Network (PSTN) or a cellular network, an intranet, and/or the Internet. For example, the mobile device 14 may connect to the server 16 by a way of an internet connection through a cellular data signal or a wi-fi signal from a wi-fi router.

In an embodiment, the server 16 is implemented using cloud services, such as those offered by Amazon or Microsoft. The mobile device 14 comprises a processor 20 and a memory 22, which, in embodiments, is comprised in a non-volatile physical memory device. The mobile device 14 is operative to run the software application or part of the software application. The server 16 comprises a processor 24 and a memory 26, which, in embodiments, is comprised in a non-volatile physical memory device. The server 16 is operative to run the software application or part of the software application. Any server or server cluster of the one or more servers or server clusters, if plural, which are comprised by the illustrated system server 16 or by another embodiment of a system server according to the disclosure, may be operative to perform a subset of, or all, the server functions described herein, either independently of or in response to input from one or more other servers or server clusters, and either solely or in conjunction with one or more other servers or server clusters.

A “server” may refer to a physical server architecture comprised in a single physical machine (such as one of the illustrated computing machines or devices 18), a physical server architecture distributed across multiple physical machines, or a virtual server architecture comprised in one physical machine or distributed across multiple physical or virtual machines. Likewise, a “processor” may refer to one, all, or a subset of the processors 20, 24 of the mobile device 14 and the server 16, or of the processors of a mobile device and server according to another embodiment of the disclosure.

In embodiments including the illustrated embodiment, each listing 21 is more particularly a listing of a home for sale. The listing 21 includes details about the home, such as address/location, type/style of construction, numbers of bedrooms and bathrooms, square footage, school district, seller's asking price, last sold price, etc. [TOSH: Does a universal “MLS” database come into play here, and if so, can you describe how it is used in a sentence or two?] As described in more detail below, in accordance with the method 12, the software application includes instructions for the server 16 to apply user input from the mobile device 14 to narrow an initial set 28 of the listings 21 down to a focused selection 30 of the listings 21 that correspond to the user input, and for the user's mobile device 14 to display the focused selection 30 to a user on a touch screen display 32 of the mobile device 14.

In embodiments, the initial listings set 28 comprises the entire database 19 of listings 21. In other embodiments, the initial listings set 28 comprises a subset of m listings 21, designated in FIG. 1 as listings 21(1 to m), extracted from the database 19. For example, the m listings 21 may be a predetermined number m of the listings 21 that are geographically nearest to a reference location (where the reference location may be a geographic point or a geographic area), where the predetermined number m is less than or equal to the total number of listings 21 in the database 19. Alternatively, the m listings 21 may be all of the listings 21 located within the reference location (as a geographic area) or within a predetermined distance of the reference location (as a geographic point or area).

The reference location may be a current location of the mobile device 14 (which may be detected by a suitable GPS system, not shown, and transmitted to the server 16 by the mobile device 14 and/or by the GPS system itself). Alternatively, the reference location may be a location specified by the user, such as by using the mobile device 14 to input a desired location into a settings menu of the software application, which desired location is stored in the mobile device memory 22 and/or the server memory 26, to be used in processing subsequent searches by the user. In embodiments, the reference location is a single geographic point, and when the initial set 28 is a set of listings within a predetermined distance thereof, the predetermined distance is likewise specified by the user, which may likewise be done by the user using the mobile device 14 to select and apply a setting of the software application. In other embodiments, the reference location is a desired area, and the initial set 28 may include all listings 21 in the desired area, or it may include all listings 21 that are either in or within a predetermined distance of the desired area.

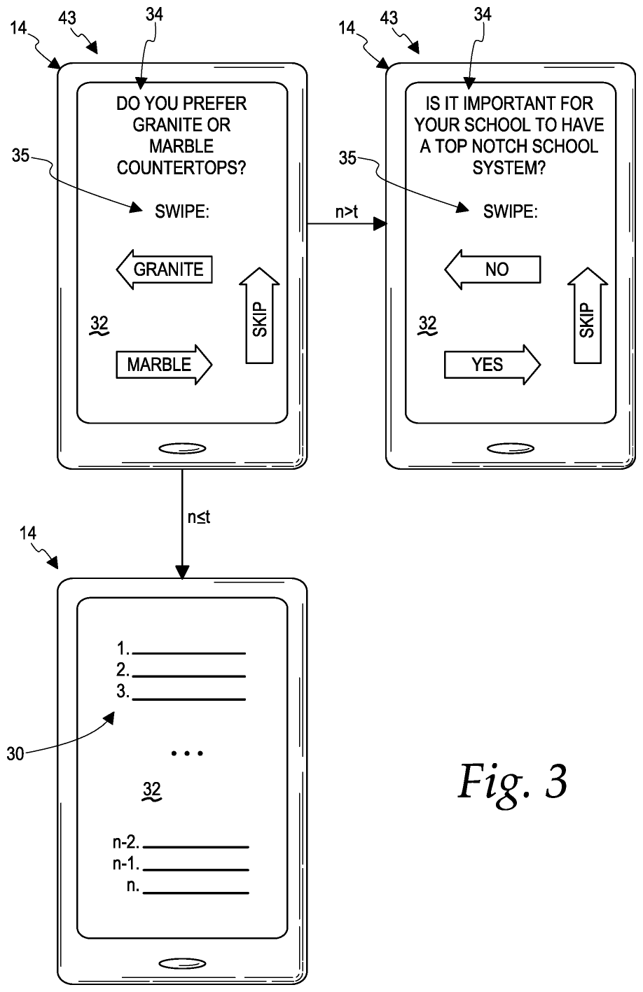

A software implemented method 12 of facilitating real estate transactions is now described. The method steps shown in the block diagram of FIG. 2 and described in detail here, with reference to FIGS. 2-3, are to be understood as being performed by the mobile device 14 and/or the server 16 automatically, pursuant to instructions comprised in the software application. Accordingly, in a receive search request step 33, the mobile device 14 receives input from a buyer user requesting to search the database 19 of real estate listings 21. For example, the buyer user may be searching for one or more listings 21 of interest for a prospective transaction, such as a home purchase.

In an initiate search step 37, the mobile device 14 submits the search request to the server 16, together with one or more criteria for determining an initial set 28 of listings 21(1 to m) selected from the database 19 of listings 21(all), such as one of the location criteria described above. In a determine initial listings set step 39, the server 16 then identifies the m listings 21(1 to m) of the initial listings set 28 and stores the initial listings set in the server memory 26. If the number m is not predefined, but rather is a total number of listings satisfying a location criterion, for example, an initial completion check step 41 is then performed, to determine whether the initial listings set 28 is already small enough to be designated as a focused listing selection 30 for delivery to the mobile device 14. If m is predefined, the method 12 proceeds to a question step 43 described further below.

In the initial filter completion check step 41, either the mobile device 14, having received a message from the server 16 indicating the initial listings set number m of listings, or the server 16 itself, compares the initial set number m of listings 21 to a focus target number t of listings 21 to be included in the focused listings selection 30. The focus target number t, which may, for example, be a number from one to twenty, a number from five to fifteen, or the number ten, may be predetermined by the software application or selected by a buyer user. For example, the buyer user may access a settings menu to set a focus target number t to be used for all searches, in the manner described above for setting a reference location, or the buyer user may newly specify a focus target number t concurrently with submitting each search request. If the mobile device 14 or the server 16 determines that the initial set number m of listings 21 is less than or equal to the focus target number t, then the method bypasses a question step 43 and proceeds to a designate focused listings selection step 46. If, instead, it is determined that the initial set number m of listings 21 is greater than the focus target number t, then the method 12 proceeds to the question step 43.

In the question step 43, as illustrated in greater detail in FIG. 3, in response to a message from the server 16 indicating, or its own processor 24 determining, that m is greater than t, the mobile device 14 displays to the user on the touch screen display 32 a question 34 or sequence of questions 34 designed to narrow down the initial listings set 28 to the focused listing selection 30. The questions 34 may include, for example, “Do you prefer granite or marble countertops?” and “Is it important for your home to have a top-notch school system?”.

In addition, the mobile device 14 displays answering instructions 35 to the user on the touch screen display 32 for answering the question 34 by swiping left or right to indicate an answer 36. The answering instruction 35 may be displayed whenever a question 34 is displayed, as illustrated in the drawings, prior to displaying each question 34, or less frequently, such as only once per user as a “tutorial” upon installation or initiation of the app, or only once per search as a refresher/reminder.

The answering instructions 35 may indicate to the user that swiping left in response to the previous example questions 34 chooses “granite” or “no” as the answer 36, and that swiping right chooses “marble” or “yes” as the answer 36. In embodiments, the instructions are verbal, such as the instruction, “Swipe left for granite; swipe right for marble” or “Swipe left for no; swipe right for yes.” In other embodiments, the instructions 35 are visual and include still images, such as the word “granite” displayed on or near a left arrow symbol and the word “marble” displayed on or near a right arrow symbol, as shown in FIG. 3. In other embodiments, not shown, the answering instructions 35 are visual and include animations/short video sequences, such as an animation of a full-screen image moving, as if being dragged, to the left and then to the right on the touch screen display 32, or an animation of a fingertip swiping left and then right across the touch screen display 32, as the answers corresponding to a left swipe and then a right swipe are displayed. In an embodiment, the user would then answer to the question 34 by swiping left or right on the touch screen display 32. In other embodiments, including in the illustrated embodiment, the user may alternatively submit “skip” as an answer 36 to a question 34, in response to which the mobile device 14 is instructed to transmit the “skip” answer 36 to the server 16, in response to which the server 16 is instructed to return to the step 43 and transmit a new question 34 to the mobile device 14. This allows the user to avoid filtering out potentially desirable listings 21 based on a criterion that is relatively unimportant to the user. In such embodiments, the answering instructions 35 further include instructions for the user to swipe up to skip the question 34. In still other embodiments, the user may swipe up, down, left, or right to submit a corresponding one of up to four different answers 36, which may or may not include a “skip” answer, to a question 34.

In response to the user submitting an answer 36 to a question 34, the mobile device 14 inputs the user answer 36 in an input user answer step 47, followed by transmitting the user answer 36 to the server 16 in a transmit user answer step 49. The server 16 is then instructed to perform a filter listings step 52, the filter listings step 52 including removing listings 21, if any, that do not fit the answer 36, from the initial listings set 28, or from the listings 21 remaining from the initial listings set 28 following the performance of any previous filter listings step(s) 51. In an embodiment, in response to an answer 36 of “granite” to the above question 34 about the user's countertop preference, the filter listings step 52 includes the server 16 removing only those listings 21 with marble countertops to produce a narrowed set of listings 21. In response to the same user answer 36, in another embodiment, the filter listings step 52 includes the server 16 removing all listings 21 that do not have granite countertops, including not only those listings 21 with marble countertops, but also those listings 21 with countertops of other non-granite materials.

In another embodiment, at least some listings 21 include a school system rating, and the school system rating that is measurable against a “top-notch school system” criterion of the software application. Accordingly, in response to a user answer 36 of “yes” to the question 34 whether it is important for the user's home to have a top-notch school system, the filter listings step 52 includes the server 16 identifying and removing from the listings 21 remaining from the initial listings set 28 all listings 21 having a school system rating that fails the “top-notch school system” criterion. In another embodiment, the filter listings step 52 includes the server 16 identifying and removing from the listings 21 remaining from the initial listings set 28 all listings 21 lacking a school system rating that satisfies the “top-notch school system” criterion, including those that lack any school system rating.

In an embodiment, after each iteration of the filter listings step 52, a filter completion check step 54 is performed, in which a remaining number n of listings 21 from the initial listings set 28 is compared to the focused target number t of listings. If n is greater than t, the method returns to the question step 43 and the mobile device 14 displays another question 34 on the touch screen display 32. If n is less than or equal to t, the server 16 performs the designate focused listings selection step 46, designating the n remaining listings 21 as the focused listing selection 30. The server 16 then transmits the focused listing selection 30 to the mobile device 14 in a deliver focused listings selection step 56 48, and the mobile device 14 then displays the focused listing selection 30 on the touch screen display 32 in a display focused listings step 58.

The focused listing selection 30 is displayed in a format that permits the user to browse through and interact with the displayed listings 21 by tapping and/or swiping the touch screen display 32. In an embodiment, only condensed or abbreviated content of each listing 21 is included in the displayed focused listing selection 30, and the user is permitted to tap on a selected listing 21 to view its full contents. In another embodiment, a user can interact with the full and/or condensed display of a listing 21 to request and/or schedule a showing of the listing 21 and/or submit a purchase offer for a listing 21.

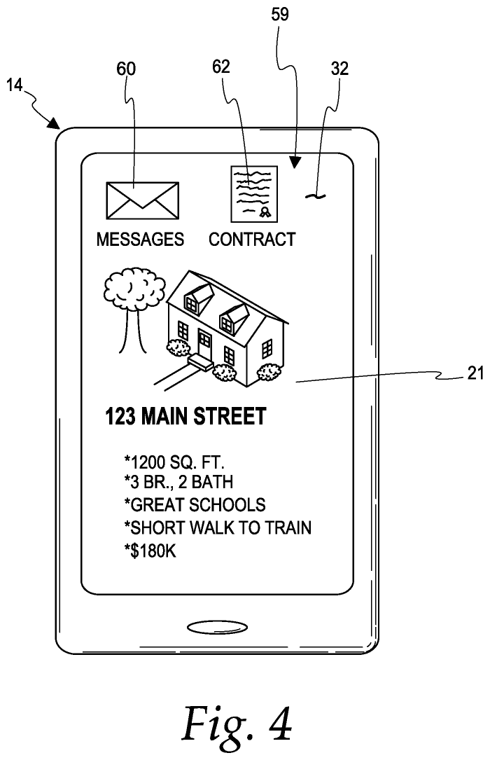

In an embodiment, the software application has a buyer dashboard interface 59, as shown in FIG. 4, which includes a messaging tool 60 that enables a user to send and receive messages to and from a seller of the listing 21, such as by the server 16 sending and receiving email communications to and from an email address that the seller has registered with the system 10, such as by using the software application on the seller's own mobile device 14 or other computing device to create a seller account The system 10 can be adapted and configured to maintain the confidentiality of the seller's email address and/or other private or personal seller information associated with the seller account, such as by storing the private or personal seller information in the server memory 26 in an encrypted format and/or requiring a password or other authentication to be accessed. The messaging tool 60 enables the buyer to negotiate a contract through direct communication with the seller. In an embodiment, a contract can be generated using a contract tool 62 on the buyer dashboard interface, or a contract prepared outside of the system 10 may be uploaded to a buyer's and/or a seller's account on the system 10 via the software application on a mobile device 14 of the buyer or seller, or via a system website accessed via a web browser running on another Internet-connected device. In embodiments, the buyer's and/or seller's accounts can be accessed using login credentials stored by the server 16 in association with the respective user's account.

These and other advantages of the invention will be further understood and appreciated by those skilled in the art by reference to the following written specification, claims and appended drawings. Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

The foregoing description of the disclosure has been presented for purposes of illustration and description and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification but be defined by the claims set forth below. In addition, although narrow claims may be presented below, it should be recognized that the scope of this invention is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional inventions are not dedicated to the public and the right to file one or more applications to claim such additional inventions is reserved.

What is claimed is:

1. A real estate database search system comprising:
a server, the server comprising a server processor and a server memory;
a mobile device, the mobile device comprising a mobile device processor, a mobile device memory, and a touch screen display, the mobile device being communicatively linked to the server by a network;
a software application, the server and the mobile device being adapted to run the software application to:
access, by the server, a database of real estate listings;
determine, by the server, an initial set of the listings from the database based on at least one criterion transmitted to the server by the mobile device;
determine whether a number of listings in the initial set of the listings from the database is greater than a focus target number of listings;
in response to determining that the number of listings in the initial set of listings is not greater than the focus target number of listings, designate, by the server, the initial set of the listings as a focused listings selection, deliver, by the server, the focused listings selection to the mobile device, and display, by the mobile device, the focused listings selection on the touch screen display;
in response to determining that the number of listings in the initial set of listings is greater than the focus target number of listings, display, by the mobile device, a question on the touch screen display;
input, by the mobile device, a user answer to the question, the user answer being indicated by the user swiping the touch screen display in a selected one of a plurality of directions to indicate a selected one of a corresponding plurality of answers;
transmit, by the mobile device, the user answer to the server;
filter, by the server, the initial set of listings to remove listings based on the user answer;
determine whether a number of remaining listings from the initial set is greater than the focus target number of listings;
in response to determining that the number of remaining listings from the initial set is not greater than the focus target number of listings, designate, by the server, the remaining listings as a focused listings selection, deliver, by the server, the focused listings selection to the mobile device, and display, by the mobile device, the focused listings selection on the touch screen display;
in response to determining that the number of remaining listings from the initial set is greater than the focus target number of listings, repeat the steps of displaying a question by the mobile device, inputting a user answer by the mobile device, transmitting the user answer to the server by the mobile device, filtering by the server the remaining listings from the initial set to remove listings based on the user answer, and determining whether the number of remaining listings from the initial set is greater than the focused target number of listings, until determining that the remaining number is not greater than the focused target number, and in response to said determining, proceeding to said designating and delivering the focused listings selection by the server and said displaying the focused listings selection by the mobile device.

2. The system of claim 1 wherein said displaying the focused listings selection by the mobile device comprises displaying abbreviated contents of each listing of the selection so as to be adapted to permit a user of the mobile device to interact with the touch screen display so as to cause a listing to be expanded so that its full contents are displayed on the touch screen display.

3. The system of claim 1 wherein said displaying the focused listings selection by the mobile device comprises displaying a listing of the selection so as to be adapted to permit a user of the mobile device to interact with the touch screen display so as to transmit a showing request for the listing to another electronic device.

4. The system of claim 1 wherein said displaying the focused listings selection by the mobile device comprises displaying a listing of the selection so as to be adapted to permit a user of the mobile device to interact with the touch screen display so as to transmit a purchase offer for the listing to another electronic device.

5. The system of claim 1 wherein said displaying the focused listings selection by the mobile device comprises displaying a listing of the selection so as to be adapted to permit a user of the mobile device to interact with the touch screen display so as to generate a purchase contract for the listing.

6. A real estate database search method comprising:
running a software application on a server and a mobile device to:
access, by the server, a database of real estate listings;
determine, by the server, an initial set of the listings from the database based on at least one criterion transmitted to the server by the mobile device;
determine whether a number of listings in the initial set of the listings from the database is greater than a focus target number of listings;
in response to determining that the number of listings in the initial set of listings is not greater than the focus target number of listings, designate, by the server, the initial set of the listings as a focused listings selection, deliver, by the server, the focused listings selection to the mobile device, and display, by the mobile device, the focused listings selection on the touch screen display;
in response to determining that the number of listings in the initial set of listings is greater than the focus target number of listings, display, by the mobile device, a question on the touch screen display;
input, by the mobile device, a user answer to the question, the user answer being indicated by the user swiping the touch screen display in a selected one of a plurality of directions to indicate a selected one of a corresponding plurality of answers;
transmit, by the mobile device, the user answer to the server;
filter, by the server, the initial set of listings to remove listings based on the user answer;
determine whether a number of remaining listings from the initial set is greater than the focus target number of listings;
in response to determining that the number of remaining listings from the initial set is not greater than the focus target number of listings, designate, by the server, the remaining listings as a focused listings selection, deliver, by the server, the focused listings selection to the mobile device, and display, by the mobile device, the focused listings selection on the touch screen display;
in response to determining that the number of remaining listings from the initial set is greater than the focus target number of listings, repeat the steps of displaying a question by the mobile device, inputting a user answer by the mobile device, transmitting the user answer to the server by the mobile device, filtering by the server the remaining listings from the initial set to remove listings based on the user answer, and determining whether the number of remaining listings from the initial set is greater than the focused target number of listings, until determining that the remaining number is not greater than the focused target number, and in response to said determining, proceeding to said designating and delivering the focused listings selection by the server and said displaying the focused listings selection by the mobile device.

7. The method of claim 6 wherein said displaying the focused listings selection by the mobile device comprises displaying abbreviated contents of each listing of the selection so as to permit a user of the mobile device to interact with the touch screen display so as to cause a listing to be expanded so that its full contents are displayed on the touch screen display.

8. The method of claim 6 wherein said displaying the focused listings selection by the mobile device comprises displaying a listing of the selection so as to permit a user of the mobile device to interact with the touch screen display so as to transmit a showing request for the listing to another electronic device.

9. The method of claim 6 wherein said displaying the focused listings selection by the mobile device comprises displaying a listing of the selection so as to permit a user of the mobile device to interact with the touch screen display so as to transmit a purchase offer for the listing to another electronic device.

10. The method of claim 6 wherein said displaying the focused listings selection by the mobile device comprises displaying a listing of the selection so as to permit a user of the mobile device to interact with the touch screen display so as to generate a purchase contract for the listing.
